(19) United States
(12) Patent Application Publication
(10) Pub. No.: US 2026/0295932 A1
(43) Pub. Date: Oct. 1, 2026

(54) SUSTAINABLE 3D PRINTED SPARKLE AND HIDE STRUCTURE

(71) Applicant: SIGNIFY HOLDING B.V., EINDHOVEN (NL)

(72) Inventor: PETER JOHANNES MARTINUS BUKKEMS, DEURNE (NL)

(21) Appl. No.: 19/478,370

(22) PCT Filed: Apr. 12, 2024
(86) PCT No.: PCT/EP2024/060074

§ 371 Date: Oct. 24, 2025

(30) Foreign Application Priority Data
Apr. 24, 2023 (EP) 23169375.5

(51) Int. Cl. B29C 64/118; B29L 31/00; B33Y 10/00; B33Y 80/00

(52) U.S. Cl. CPC B29C 64/118; B29K 2995/0026; B29L 2031/747; B33Y 10/00; B33Y 80/00

(57) ABSTRACT

The invention provides a method for producing a 3D item by means of fused deposition modelling, the method comprising: a 3D printing stage comprising layer-wise 3D printable material, to provide the 3D item comprising 3D printed material, wherein the 3D item comprises a plurality of layers of 3D printed material, wherein: (a) the method comprises generating a stack comprising n layers of 3D printed material on top of each other by depositing 3D printable material along n printing paths (A_{Pn}), wherein the n printing paths (A_{Pn}) and printing conditions are selected such that the stack comprises stack sections and stack modulations; (b) for the stack sections applies: (i) an n^{th} layer is configured on an (n−1)^{th} layer and/or (ii) the (n−1)^{th} layer is configured on an (n−2)^{th} layer; (c) for (at least part of) the stack modulations applies: an n^{th} layer is partly configured on an (n−1)^{th} layer and partly on an (n−2)^{th} layer, and the (n−1)^{th} layer is partly configured between the n^{th} layer and the (n−2)^{th} layer; and (d) n>3, and the 3D printable material comprises a light transmissive material.

### FIELD OF THE INVENTION

The invention relates to a method for manufacturing a 3D (printed) item. Further, the invention relates to a software product for executing such method. The invention also relates to the 3D (printed) item obtainable with such method. Further, the invention relates to a lighting device including such 3D (printed) item.

### BACKGROUND OF THE INVENTION

The 3D printing of articles including spatially different properties is known in the art. US 2018/0093412, for instance, describes a method of printing a 3D article comprising selectively depositing a first portion of build material in a fluid state onto a substrate to form a first region of build material; selectively depositing a first portion of support material in a fluid state to form a first region of support material; and selectively depositing a second portion of build material in a fluid state to form a second region of build material, wherein the first region of support material is disposed between the first region of build material and the second region of build material in a z-direction of the article.

### SUMMARY OF THE INVENTION

Within the next 10-20 years, digital fabrication will increasingly transform the nature of global manufacturing. One of the aspects of digital fabrication is 3D printing.

Currently, many different techniques have been developed in order to produce various 3D printed objects using various materials such as ceramics, metals, and polymers. 3D printing can also be used in producing molds which can then be used for replicating objects.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast, low cost and can be used for printing complicated 3D objects. Such printers are used in printing various shapes using various polymers. The technique is also being further developed in the production of LED luminaires and lighting solutions. In lighting applications, the lines in 3D printed items often cause undesired optical artifacts. Such artifacts may be decreased when a diffuser is used. However, using a diffuser may lower the efficiency of a luminaire. Also, the very smooth 3D printed structures appear very sensitive for defects.

There is a desire to control optical properties of 3D printed items. However, current methods do not provide such options or only in a limited way. Hence, it is an aspect of the invention to provide an alternative 3D printing method and/or 3D (printed) item which preferably further at least partly obviate(s) one or more of above-described drawbacks. The present invention may have as object to overcome or ameliorate at least one of the disadvantages of the prior art, or to provide a useful alternative.

Hence, in a first aspect the invention provides a method for producing a 3D item (“item” or “3D printed item”) by means of fused deposition modelling. In embodiments, the method may comprise a 3D printing stage comprising layer-wise depositing (an extrudate comprising) 3D printable material, to provide the 3D item comprising 3D printed material.

Deposition may especially be done on a receiver item. Especially, the 3D item may in embodiments comprise a plurality of layers of 3D printed material. The method may in embodiments especially comprise generating a stack comprising n layers of 3D printed material on top of each other by depositing 3D printable material along n printing paths (A_{Pn}). In embodiments, the n printing paths (A_{Pn}) and printing conditions may be selected such that the stack comprises stack sections and stack modulations. In embodiments, for the stack sections may apply: an n^{th} layer is (only) configured on an (n−1)^{th} layer and/or the (n−1)^{th} layer is (only) configured on an (n−2)^{th} layer. In embodiments, for (at least part of) the stack modulations may apply: an n^{th} layer is partly configured on an (n−1)^{th} layer and partly on an (n−2)^{th} layer, and the (n−1)^{th} layer is partly configured between the n^{th} layer and the (n−2)^{th} layer. In further embodiments, n≥3. The 3D printable material may in embodiments comprise a light transmissive material. Hence, in specific embodiments, the invention provides a method for producing a 3D item by means of fused deposition modelling, the method comprising: a 3D printing stage comprising layer-wise 3D printable material, to provide the 3D item comprising 3D printed material, wherein the 3D item comprises a plurality of layers of 3D printed material, wherein: (a) the method comprises generating a stack comprising n layers of 3D printed material on top of each other by depositing 3D printable material along n printing paths (A_{Pn}), wherein the n printing paths (A_{Pn}) and printing conditions are selected such that the stack comprises stack sections and stack modulations; (b) for the stack sections applies: (i) an n^{th} layer is configured on an (n−1)^{th} layer and/or (ii) the (n−1)^{th} layer is configured on an (n−2)^{th} layer; (c) for at least part of the stack modulations applies: an n^{th} layer is partly configured on an (n−1)^{th} layer and partly on an (n−2)^{th} layer, and the (n−1)^{th} layer is partly configured between the nth layer and the (n−2)^{th} layer; and (d) n≥3, and the 3D printable material comprises a light transmissive material.

With such method, it may be possible to provide 3D items such as luminaires and/or windows with high control over optical properties. E.g. the method may provide a lighting device housing configured to hide the light source, which may improve aesthetics. Further, such lighting device housing may provide good color mixing and have a relatively high fault tolerance. Also, a diffuser may be provided from a transmissive (or even transparent) material. As a single (clear) material may be used, the item can be easily recycled and hence the method of the invention may be a sustainable solution. Further, the method may provide 3D items wherein artefacts (such as from one or more of production and damaging) may be less noticeable. Yet, the invention allows at least partially hiding characteristic (3D printing) lines between 3D printed layers.

As indicated above, the method may comprise depositing during a printing stage 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. In embodiments, the 3D printable material may be printed as a filament and deposited as such. The 3D printable material may be provided as filament or may be formed into a filament. Hence, whatever starting materials are applied, a filament comprising 3D printable material may be provided by the printer head and 3D printed. The term “extrudate” may be used to define the 3D printable material downstream of the printer head, but not yet deposited. The latter may be indicated as “3D printed material”. In fact, the extrudate may be considered to comprise 3D printable material, as the material is not yet deposited. Upon deposition of the 3D printable material or extrudate, the material may thus be indicated as 3D printed material. Essentially, the materials may be the same material, as the thermoplastic material upstream of the printer head, downstream of the printer head, and when deposited, may essentially be the same material(s).

Herein, the term “3D printable material” may also be indicated as “printable material”. The term “polymeric material” may in embodiments refer to a blend of different polymers but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

As mentioned above, the invention may provide a method for producing a 3D item comprising a plurality of layers of 3D printed material by means of fused deposition modelling. In embodiments, the method may comprise a 3D printing stage further comprising layer-wise depositing on a receiver item an extrudate comprising 3D printable material. Especially, the 3D printable material may be deposited on a receiver item, to provide the 3D item comprising 3D printed material.

The 3D item may especially comprise m layers of 3D printed material. In embodiments, m may be at least 3, more especially at least 5, such as at least 10, especially at least 20, such as at least 50. Hence, the method may comprise generating the 3D item, wherein the 3D item comprises m layers. Especially, during generating the multiple layers, a stack, as described herein, is generated. In embodiments, all layers of the 3D item may be part of the stack, as described herein. In other embodiments, a subset of all layers of the 3D item may be part of the stack, as described herein. Yet, in embodiments, at least parts of three or more layers of the 3D item may be comprised by the stack, as described herein, whereas other parts of three or more layers may not be comprised by the stack, as described herein.

In the most straightforward 3D printing known method, a stack of 3D printed layers may be generated wherein the layers are essentially on top of each other. There may be some offset, e.g. to make a curvature in the z-direction, but even then, the layers may substantially be on top of each other and may follow substantially parallel printing paths. In the present invention, however, substantial deviations from substantially parallel printing paths may be included, which may lead to stack sections which may approximately or essentially be the same as obtained in the most straightforward 3D printing, and stack modulations.

As indicated above, the method may in embodiments comprise generating a stack comprising a plurality of layers. The stack may in embodiments form a part of the 3D item, such as a wall. In (other) embodiments, the 3D item may essentially consist of the stack. In embodiments, the stack may comprise (at least) n layers of 3D printed material configured (at least partially) on top of each other. In embodiments, n≥3, such as n≥4, especially n≥5. In embodiments, the number n may especially be a floating number. E.g. n may refer to the 7^{th} layer, then n−1 refers to the 6^{th} layer and n−2 refers to the 5^{th} layer. Hence, by way of example in a stack of six layers, within the concept of the invention, each of layers 3-6 may be an n^{th} layer, and each of layers 1-4 may be an (n−2)^{th} layer. In embodiments, m≥n. In (other) embodiments, n=m.

Especially, the method may in embodiments comprise depositing 3D printable material along n printing paths (A_{Pn}). A printing path may in embodiments refer to a path (or route) that the printer head and/or printer nozzle takes during the deposition of (a layer of) the 3D printable material. In embodiments, the printing path(s) may be defined in a horizontal (x-y) plane(s). Especially, the printing path may in embodiments refer to a 2D path. In other embodiments, the printing path may be a 3D path (e.g. in spiralized designs). In such embodiments, a height of the printer head and/or printer nozzle may not be taken into account in a definition of the “printing path” as used here. Hence, in embodiments, the printing path may be a 2D projection of a 3D movement of the printer head and/or printer nozzles. Each of the n layers of the stack may be deposited along their respective printing path. Hence, in embodiments, the method may comprise depositing the n layers along n printing paths (A_{Pn}). In embodiments, one or more of the n printing paths (A_{Pn}) may be identical. For instance, the n^{th} printing path (of an n^{th} layer) and the (n−2)^{th} printing path (of the (n−2)^{th} layer) may in specific embodiments be the same. Especially, however, at least two printing (A_{Pn}) may differ. In alternative embodiments, the n printing paths (A_{Pn}) may all be different. The n printing paths (A_{Pn}) and printing conditions may in embodiments be selected such that the stack comprises stack sections and stack modulations.

For the stack sections may in embodiments apply that an n^{th} layer is configured on an (n−1)^{th} layer. Additionally or alternatively, the (n−1)^{th} layer in the stack section may in embodiments be configured on the (n−2)^{th} layer. In specific embodiments for the stack sections may apply that the n^{th} layer is only configured on an (n−1)^{th} layer. Additionally or alternatively, the (n−1)^{th} layer in a stack section may in embodiments only be configured on the (n−2)^{th} layer. The stack sections may in embodiments comprise a stack (section) as commonly used in FDM printing. In the stack section, the layer(s) may have a first layer height (H₁) and a first layer width (W₁).

For (at least part of) the stack modulations may in embodiments apply that an n^{th} layer is partly configured on an (n−1)^{th} layer and partly on an (n−2)^{th} layer. Additionally or alternatively, the (n−1)^{th} layer may be partly configured between the n^{th} layer and the (n−2)^{th} layer. In this way, in a stack modulation, the n^{th} layer may be partly covering a side of the (n−1)^{th} layer. In other words, the (n−1)^{th} layer may be partly hidden from an observer (at one side) of the stack. In the stack modulation, the layer may have a (largest) second layer height (H₂) and a (corresponding) second layer width (W₂). Such stack modulations may optically interrupt the (n−1)^{th} layer. Especially, such stack modulations may provide optical effects to the stack and/or 3D item (see also below). In embodiments, part of a layer may be comprised by a stack section and another part of this same layer may be comprised by a stack modulation.

The stack modulations may in embodiments comprise a first part of the stack modulation. In the first part of the stack modulation, an n^{th} layer may in embodiments be partly configured on an (n−1)^{th} layer and partly on an (n−2)^{th} layer. Additionally or alternatively in the first part of the stack modulation the (n−1)^{th} layer may in embodiments be partly configured between the nth layer and the (n−2)^{th} layer. In embodiments, the stack modulations may in embodiments further comprise a second part of the stack modulation. In embodiments, for a second part of the stack modulation may apply that an n^{th} layer is (only) configured on an (n−2)^{th} layer. Hence, in specific embodiments, the stack modulation comprises a first part of the stack modulation and a second part of the stack modulation, wherein for a first part of the stack modulation applies: an n^{th} layer is partly configured on an (n−1)^{th} layer and partly on an (n−2)^{th} layer, and the (n−1)^{th} layer is partly configured between the n^{th} layer and the (n−2)^{th} layer; and wherein for a second part of the stack modulation applies: an n^{th} layer is configured on an (n−2)^{th} layer. Especially, a second part of the stack modulation may be configured between two first parts of the stack modulation. Following for instance (along a virtual printing path), the one or more layers of the stack may show a following structure: A(BCBA)q, wherein q is at least 1, wherein A refers to a stack section, B refers to a first part of the stack modulation, and C refers to a second part of the stack modulation.

Further note that phrases like “n^{th} layer is partly configured on an (n−1)^{th} layer and partly on an (n−2)^{th} layer”, and similar phrases, may imply that part of the n^{th} layer may configured on part of an (n−1)^{th} layer and on part of an (n−2)^{th} layer”. Similarly, phrases like “n^{th} layer is configured on an (n−2)^{th} layer” and similar phrases, may imply that part of the n^{th} layer may configured on part of an (n−2)^{th} layer. Further, the phrase “for (at least part of) the stack modulations . . . ” and similar phrases may in embodiments refer to respective parts of one or more of the stack modulations (for instance, this may imply that for one or more stack modulations may apply that for such stack modulations, a part of such stack modulation may comprise a first part of the stack modulation and a second part of the stack modulation).

The optical effects provided by the stack modulation may, amongst other things, depend on the 3D printed (and hence 3D printable) material used. In embodiments, the 3D printable material may comprise a light transmissive material. The 3D printable material may in embodiments especially be transmissive for (one or more wavelengths of) visible light. Especially, the 3D printable material may in embodiments be transmissive for white light. In further embodiments, the 3D printable material may in embodiments comprise a light transparent material. The 3D printable material may in embodiments especially be transparent for visible light. Hence, the 3D printed material of the stack may be light transparent. However, due to the stack modulations, the stack may appear substantially translucent.

Especially, the light transmissive material may have a light transmission in the range of 50-100 %, especially in the range of 70-100%, for light having a wavelength selected from the visible wavelength range. Herein, the term “visible light” especially relates to light having a wavelength selected from the range of 380-780 nm.

The transmission (or light permeability) can be determined by providing light at a specific wavelength with a first intensity to the light transmissive material under perpendicular radiation and relating the intensity of the light at that wavelength measured after transmission through the material, to the first intensity of the light provided at that specific wavelength to the material (see also E-208 and E-406 of the CRC Handbook of Chemistry and Physics, 69th edition, 1088-1989).

In specific embodiments, a material may be considered transmissive when the transmission of the radiation at a wavelength or in a wavelength range, especially at a wavelength or in a wavelength range of radiation generated by a source of radiation as herein described, through a 1 mm thick layer of the material, especially even through a 5 mm thick layer of the material, under perpendicular irradiation with said radiation is at least about 20%, such as at least 40%, like at least 60%, such as especially at least 80%, such as at least about 85%, such as even at least about 90%.

Herein, values for transmission especially refer to transmission without taking into account Fresnel losses at interfaces (with e.g. air). Hence, the term “transmission” especially refers to the internal transmission. The internal transmission may e.g. be determined by measuring the transmission of two or more bodies having a different width over which the transmission is measured. Then, based on such measurements the contribution of Fresnel reflection losses and (consequently) the internal transmission can be determined. Hence, especially, the values for transmission indicated herein, disregard Fresnel losses.

In addition to a high transmission for the wavelength(s) of interest, also the scattering (of the 3D printable material or 3D printed material as such) for the wavelength(s) may especially be low. Hence, the mean free path for the wavelength of interest only taking into account scattering effects (thus not taking into account possible absorption (which should be low anyhow in view of the high transmission)), may be at least 0.5 times the width of a layer in the stack, such as at least the width of such layer, like at least twice the width of such layer. For instance, in embodiments the mean free path only taking into account scattering effects may be at least 5 mm, such as at least 10 mm. The wavelength of interest may especially be the wavelength at maximum intensity of a light source when the 3D item is applied in a lighting application. The term “mean free path” is especially the average distance a ray will travel before experiencing a scattering event that will change its propagation direction.

In embodiments, a layer comprising the light transmissive material may essentially consist of the light transmissive material. In specific embodiments, the layer comprising the light transmissive material may be a light transparent layer. Especially, the light transmissive layer, such as the light transparent layer, may in embodiments have an absorption length and/or a scatter length of at least the width (or thickness) of the light transmissive layer, such as at least twice the width of the light transmissive layer. In further embodiments, the absorption length and/or a scatter length may be at least 0.5*W, such as at least W, like at least 2*W, especially at least 5*W. The absorption length may be defined as the length over which the intensity of the light along a propagation direction due to absorption drops with 1/e. Likewise, the scatter length may be defined as the length along a propagation direction along which light is lost due to scattering and drops thereby with a factor 1/e. Here, the length may thus especially refer to the distance between a primary face and a secondary face of the light transmissive layer, with the light transmissive material configured between the primary face and the secondary face. Further, the light transmissive layer may have a relatively low scattering for the light. In specific embodiments the light transmissive layer a scattering mean free path (ls) for the visible light, wherein in specific embodiments ls>⅕*W. For instance, in embodiments the scattering mean free path (ls) for the visible light may be selected from the range of ¼*W−20*W, such as selected from the range of ¼*W−10*W. The width W may refer to a width of a layer as such, and may in embodiments refer to the first width (W₁) of a stack section or to the second width (W₂) of a stack modulation (see also below).

In embodiments, the 3D printable material (and hence 3D printed material) may be colorless. In alternative embodiments, the 3D printable material (and hence 3D printed material) may be colored. In embodiments, the 3D printable material (and hence 3D printed material) may comprise scattering particles, and in alternative embodiments, the 3D printable material (and hence 3D printed material) may not comprise particulate material (see also below). It will be clear to a person skilled in the art that combinations of embodiments may be possible. E.g. the 3D printable material (and hence 3D printed material) may be red and transmissive for blue light.

In embodiments wherein the 3D printable material is a light transparent material, the 3D item may be a diffuser for light having a high transmission. Such diffuser may especially be useful in lighting applications as it may provide relatively high yields due to its low absorption of light. Amongst others, the diffuser function may be provided by the stack modulations. Additionally or alternatively, the light transmissive (such as transparent) 3D printed material may provide a sparkling effect in the stack modulations. Especially, a combination of the stack modulations and the layer height (H) may provide a balance between translucence and sparkling properties. In embodiments, the stack modulation may comprise a (small) lens-like shape. Such lens-like shape may provide optical effects (such as sparkling) to the stack and/or 3D item. Further embodiments on the lens-like shapes will be discussed below, in relation to the stack modulations. In embodiments, a lens-like shape may especially be convex and may at least partly comprise curved edges. In embodiments, the lens-like shape may be comprised by a continuous layer.

Hence, such lenses may in embodiments essentially be part of an (n−1)^{th} layer which partly overlaps, when seen from the side of the stack, with the n^{th} layer and/or the (n−2)^{th} layer. In such embodiments, the (n−1)^{th} layer may form a lens on one side of the stack and may be hidden for an observer from the other side of the stack. Here, the (n−1)^{th} layer is just taken as an example, as e.g. the n^{th} layer may also comprise stack modulations, partly hiding the (n−1)^{th} layer, etc.

In embodiments, a layer may comprise stack modulations only at one side of the stack. Especially, in embodiments a layer may comprise stack modulations at both sides of the stack. Hence, in specific embodiments, a layer may form lenses on both sides of the stack. In further embodiments, a layer may form lenses on alternating sides of the stack.

Such lens-like shape may be provided by differences between the printing paths, especially at a position where the nth printing path may be partially configured on the (n−2)^{th} printing path. As indicated above, the method may comprise selecting the n printing paths (A_{Pn}). Especially, an (n−1)^{th} printing path (A_{Pn-1}) (of an (n−1)^{th} layer) may in embodiments differ from an n^{th} printing path (A_{Pn}). Additionally or alternatively, the (n−1)^{th} printing path (A_{Pn-1}) may in embodiments differ from an (n−2)^{th} printing path (A_{Pn-2}). Additionally or alternatively, the n^{th} printing path (A_{Pn-1}) may in embodiments differ from the (n−2)^{th} printing path (A_{Pn-2}). Therefore, different printing paths may provide an n^{th} layer to be partly configured on an (n−1)^{th} layer and partly on an (n−2)^{th} layer, and the (n−1)^{th} layer to be partly configured between the n^{th} layer and the (n−2)^{th} layer. In this way, stack modulations may be provided. Hence, in specific embodiments, an (n−1)^{th} printing path (A_{Pn-1}) differs from an n^{th} printing path (A_{Pn}) and/or an (n−2)^{th} printing path (A_{Pn-2}), wherein the stack modulation comprises a lens-like shape. Phrases like “a first layer partly configured on a second layer”, and similar phrases, may thus in embodiments also imply that other parts of the first layer are not configured on the second layer (like in the respective stack section of where that other part of the first layer is comprised by).

The n printing paths may in embodiments have any shape. In embodiments, one or more of the (n−2)^{th} printing path (A_{Pn-2}), the (n−1)^{th} printing path (A_{Pn-1}), and the nth printing path (A_{Pn}) in the stack modulation may have an irregular shape. Additionally or alternatively, one or more of the (n−2)^{th} printing path (A_{Pn-2}), the (n−1)^{th} printing path (A_{Pn-1}), and the n^{th} printing path (A_{Pn}) in the stack modulation may in embodiments have a wave-like shape. In embodiments, the wave-like shape may comprise any wave-like shape, such as based one or more of a block wave, a sine wave, a Fourier series, a composite wave, a sawtooth wave, and a peak period wave. Thus, one or more of the (n−2)^{th} printing path (A_{Pn-2}), the (n−1)^{th} printing path (A_{Pn-1}), and the n^{th} printing path (A_{Pn}) in the stack modulation may in embodiments have a sine-like shape. Especially, (in the stack modulation) one or more of the (n−2)^{th} printing path (A_{Pn-2}), the (n−1)^{th} printing path (A_{Pn-1}), and the n^{th} printing path (A_{Pn}) may comprise a shape of an irregular sine. The term “irregular sine” may herein refer to a sine-like shape, wherein a regular sine may be distorted by variations in one or more of amplitude, period, skewness. Also other variations may occur. Especially, such variations may in embodiments vary between repeating units of the (sine-like) wave and/or within repeating units of the (sine-like) wave.

Especially, (a part of) the irregular sine may in embodiments have a varying period selected from the range of 0.5*H₁−20*H₁, such as H₁−15*H₁, especially 4*H₁−10*H₁. Thus, in embodiments, the printing path may comprise a first section and a second section. In embodiments, the first section may comprise a sine-like shape having a first amplitude, a first period and a first skewness. In embodiments, the second section may comprise a sine-like shape having a second amplitude, a second period and a second skewness. In embodiments, at least one of the first period and second period, the first amplitude and the second amplitude, and the first skewness and the second skewness may differ. In embodiments, the first section may comprise less than a full sine(-like) wave. Alternatively, the first section may in embodiments comprise at least a full sine(-like) wave. Similarly, the second section may in embodiments comprise less than a full sine(-like) wave. Alternatively, the second section may in embodiments comprise at least a full sine(-like) wave. Especially at least 80%, such as at least 90% of the periods may fall within the defined range. As indicated above, H₁ may be a layer height (H) of a part of a layer in a stack section. In embodiments wherein the 3D item and/or the stack only comprises stack modulations, H₁ may be calculated as an average layer height of a plurality of layers, such as at least 3 layers, especially at least 5 layers, more especially at least 10 layers.

In embodiments, the first layer height (H₁) may be selected from the range of 0.05-3 mm, such as from the range of 0.1-1.5 mm. In embodiments, the first layer width (W₁) may be selected from the range of 0.3-5 mm, such as from the range of 1-3 mm. In further embodiments, the irregular sine may in have a varying period selected from the range of 0.05-7 mm, such as from the range of 0.1-5 mm. Hence, in specific embodiments, one or more of the (n−2)^{th} printing path (A_{Pn-2}), the (n−1)^{th} printing path (A_{Pn-1}), and the nth printing path (A_{Pn}) comprise a shape of an irregular sine, wherein the irregular sine has a varying period selected from the range of H₁−15*H₁, wherein H₁ is a layer height (H) of a part of a layer in a stack section.

In specific embodiments, a lens-like shape of an n^{th} layer may be in contact with a lens-like shape of an (n−2)^{th} layer. More especially, in embodiments this may apply for a plurality of stack modulations. However, in other embodiments a lens-like shape of an nth layer may not be in contact with a lens-like shape of an (n−2)^{th} layer. Nevertheless, the distance between lens-like shape of an n^{th} layer may and the lens-like shape of an (n−2)^{th} layer may be less than 0.5*H₁, such as at maximum 0.25*H₁. Hence, alternatively or additionally, for a plurality of stack modulations may apply that the distance between a lens-like shape of an n^{th} layer may and the lens-like shape of an (n−2)^{th} layer may be less than 0.5*H₁. Especially when the distance is less than about 0.25*H₁, 3D printing lines may (further) be hidden.

In further embodiments, in the stack modulation each of the (n−2)^{th} printing path (A_{Pn-2}), the (n−1)^{th} printing path (A_{Pn-1}), and the n^{th} printing path (A_{Pn}) may meander around a (respective) central path (A_{C}). A maximum deviation (d) of the n^{th} printing path relative to the central path (A_{C}) may in embodiments be selected from the range of 0.05*W₁−1.5*W₁, such as from the range of 0.05*W₁−0.99*W₁, especially from the range of 0.1*W₁−0.9*W₁. In further embodiments, the maximum deviation (d) may be selected from the range of 0.1-5 mm, such as from the range of 0.5-3 mm. In this way, the n^{th} layer may be partly configured on an (n−1)^{th} layer and partly on an (n−2)^{th} layer, to provide a stack modulation. In order to maintain structural integrity of the stack (and hence 3D item), the (n−1)^{th} layer may especially have at least 5%, such as at least 7%, like at least 10% overlap with the n^{th} layer and may especially have at least 5%, such as at least 7%, like at least 10% overlap with the (n−2)^{th} layer. As indicated above, W₁ is a layer width (W) of a part of a layer in a stack section. Especially, the central paths (A_{C}) may define an overall shape of the stack (of the 3D item). Hence, in specific embodiments, in the stack modulation each of the (n−2)^{th} printing path (A_{Pn-2}), the (n−1)^{th} printing path (A_{Pn-1}), and the n^{th} printing path (A_{Pn}) meander around a central path (A_{C}), wherein a maximum deviation (d) of the n^{th} printing path relative to the central path (A_{C}) is selected from the range of 0.05*W₁−0.99*W₁, wherein W₁ is a layer width (W) of a part of a layer in a stack section.

In the stack modulations, in embodiments the central path (A_{C}) of the n^{th} layer may in embodiments not be parallel to the central path (A_{C}) of the (n−1)^{th} layer.

As indicated above, the 3D item may comprise one or more stack sections and one or more stack modulations. Especially, in embodiments, stack sections and stack modulations may be alternated within a layer. Each stack section may have a first length, wherein the first length may be measured along the printing path (A_{P}). For all stack sections within a predetermined layer of the n^{th} layer, the (n−1)^{th} layer, and the (n−2)^{th} layer, the stack sections have an accumulated first length L_{A1}. Similarly, each stack modulation may have a second length, wherein the second length may be measured along the printing path (A_{P}). For all stack modulations within a predetermined layer of the n^{th} layer, the (n−1)^{th} layer, and the (n−2)^{th} layer, the stack modulations have an accumulated second length L_{A2}. In embodiments, 0.01≤L_{A2}/L_{A1}≤10,000,000, such as 0.1≤L_{A2}/L_{A1}≤10,000, especially 0.5≤L_{A2}/L_{A1}≤1,000. Thus, in embodiments a specified layer may mostly comprise stack sections. In alternative embodiments, the specified layer may mostly comprise stack modulations. Whether L_{A2}≥L_{A1} or L_{A2}≤L_{A1} may in embodiments vary per layer. In embodiments, the resulting 3D item may mostly comprise stack sections. In alternative embodiments, the resulting 3D item may mostly comprise stack modulations. Stack sections may especially contribute to structural integrity of the 3D item. Stack modulations may especially contribute to the optical effects of the 3D item. Hence, in specific embodiments for a predetermined layer of the n^{th} layer, the (n−1)^{th} layer, and the (n−2)^{th} layer, the stack sections have an accumulated first length L_{A1} and the stack modulations have an accumulated second length L_{A2}, wherein 0.1≤L_{A2}/L_{A1}≤10,000. In embodiments wherein the wave-like shapes have a constant pitch, larger values of L_{A2}/L_{A1} may correspond to larger modulations. Herein, the term “pitch” may relate to a distance between a first lens and a second lens within one layer, wherein the first lens and the second lens are neighboring lenses configured on the same side of the stack.

In general during deposition, 3D printable material may be extruded by the 3D printer from a printer nozzle. Such general aspects are described further below. Especially in the modulation sections, a receiving surface of the n^{th} layer may in embodiments comprise different heights (of previously deposited) 3D printed material. Therefore, during deposition of the n^{th} layer, in embodiments the printer nozzle may displace (some) of the (previously deposited) 3D printed material. Especially, (some) of the (previously deposited) 3D printed material may be moved aside. In embodiments, depositing the n^{th} layer may further comprise displacing (part of) the (n−1)^{th} layer. Such displacing may in embodiments create space for the n^{th} layer on one or more of the (n−1)^{th} layer and the (n−2)^{th} layer. Hence, in specific embodiments, depositing the n^{th} layer further comprises displacing the (n−1)^{th} layer to create space for the n^{th} layer on one or more of the (n−1)^{th} layer and the (n−2)^{th} layer. In such embodiments, the displaced 3D printed material may in embodiments be pushed aside. The displacement may in embodiments provide the lens-like shape.

As indicated above, the method of the invention may comprise selecting the n printing paths (A_{Pn}) and printing conditions such that the stack comprises stack sections and stack modulations. In embodiments, the printing conditions herein may comprise one or more of (i) an extrusion rate v_{E}, (ii) a printing speed v_{P}, and (iii) a printing temperature T_{N}. These parameters are described in more detail.

In embodiments, the method may comprise selecting during the 3D printing stage the extrusion rate v_{E}. The extrusion rate may refer to the rate at which the 3D printable material is extruded from the nozzle (“printer nozzle”). An increase in the extrusion rate may increase the volume of 3D printable material deposited. This may increase the thickness of the deposited layer. Hence, when during 3D printing the extrusion rate is increased relative to the printing speed, a layer may get a larger layer width. Likewise, when during 3D printing the extrusion rate is decreased relative to the printing speed, a layer may get a smaller layer width.

Further, in embodiments, the method may comprise selecting the printing speed v_{P}. At a constant extrusion rate, the volume of 3D printable material deposited may be increased by lowering printing speed i.e. the speed at which the nozzle traverses relative to a receiver item. Hence, more 3D printable material may be deposited for every pass of the nozzle. Hence, when during the during 3D printing the printing speed is reduced while maintaining the extrusion rate constant, the layer may get a larger width. Likewise, when during the during 3D printing the printing speed is increased while maintaining the extrusion rate constant, the layer may get a smaller width.

Yet further, in embodiments, the method may comprise selecting the printing temperature T_{N}. Especially, T_{N}≥T_{P}+100° C. Here, T_{P} is the phase transition temperature. The 3D printable material may be deposited at a high temperature such as higher than the phase transition temperature. Upon cooling, the 3D printable material may cool to a temperature lower than the phase transition temperature resulting in the solidification of the 3D printable material (or 3D printed material). Hence, in this way the 3D printed material may be provided when the 3D printable material cools to a temperature lower than the phase transition temperature. Especially, the phase transition temperature T_{P} may be the melting temperature Tₘ, such as when the 3D printable material comprises a semicrystalline polymer material. Further, especially, the phase transition temperature T_{P} may be the glass transition temperature T_{g} such as when the 3D printable material comprises an amorphous polymer material.

The viscosity of the 3D printable material may be dependent on the temperature at which the 3D printable material is extruded from the nozzle. The viscosity of the 3D printable material may be decreased by increasing the printing temperature T_{N}. When increasing the temperature, the 3D printable material may become more flowable. Hence, when during the 3D printing the nozzle temperature is increased while not changing the printing speed or not substantially changing the deposition rate, at least part of the 3D printable material (or 3D printed material) of the n^{th} layer may spillover on an earlier printed layer (such as the (n−1)^{th} layer or the (n−2)^{th} layer). A higher nozzle temperature may also allow a higher extrusion rate. For comments about the extrusion rate, see also above.

The flow rate of the 3D printable material may be selected from the range of 5-100 cm³/10 min, such as 10-90 cm³/10 min, especially 20-80 cm³/10 min (e.g. as defined according to ISO 1133 12). Such mass flow rates may, in embodiments, be achieved by selecting the printing temperature T_{N} of at least 300° C., such as 350° C., especially 400° C.; however, as the printing temperature T_{N} may especially depend on the printable material used, other temperatures may also be possible. Further, in embodiments, the 3D printable material may be deposited and hence, the extrusion of 3D printable material may (also) be described in terms of deposition of 3D printable material. Especially, the 3D printable material may be deposited at a rate selected from the range of 2.5-15000 mg/s, such as 10-12000 mg/s, especially 1000-10000 mg/s. Hence, during at least part of the 3D printing stage, the flow rate of the 3D printable material may be selected from the range 5-100 cm³/10 min. Alternatively or additionally, during at least part of the 3D printing stage, the deposition rate of the 3D printable material may be selected from the range of 2.5-15000 mg/s.

Especially, the extrusion rate v_{E}, the printing speed v_{P}, and the printing temperature T_{N} may in embodiments be constant during deposition of the layers (of the stack). The term “constant” may in embodiments refer to deviate at most 10% relative to an average condition. Hence, in specific embodiments, the method comprises selecting one or more of (i) an extrusion rate v_{E}, (ii) a printing speed v_{P}, and (iii) a printing temperature T_{N} to provide the stack, wherein the extrusion rate v_{E}, the printing speed v_{P}, and the printing temperature T_{N} may be constant during deposition of the layers. Hence, instead of the term “constant” also the term “substantially constant” may be applied.

Especially, the method may comprise selecting these printing conditions such that the method provides the modulation section and the lens-like shapes. As indicated above, a part of the n^{th} layer in the stack section has a first layer height (H₁) and a part of the nth layer in the modulation section has a second layer height (H₂). In the modulation section, the n^{th} layer may be partly configured on the (n−1)^{th} layer and partly on the (n−2)^{th} layer. Especially, the (n−1)^{th} layer may be partly configured between the n^{th} layer and the (n−2)^{th} layer. To achieve such configuration of the layers, the second layer height (H₂) may especially be larger than the first layer height (H₁). Therefore, in embodiments, 1.1*H₁≤H₂≤3*H₁, such as 1.5*H₁≤H₂≤2.5*H₁, such as 1.7*H₁≤H₂≤2.2*H₁. In this way, the n^{th} layer may (partly) be configured on the (n−2)^{th} layer. Especially the (n−1)^{th} layer may partly be hidden from the view of an observer (at one side). In embodiments, the second layer height (H₂) may be selected from the range of 0.055-15 mm, such as from the range of 0.11-4.5 mm, though other values may also be possible.

In embodiments wherein the printing conditions are constant during deposition of the layers and the second layer height (H₂) may especially be larger than the first layer height (H₁), the second layer width (W₂) may especially be smaller than the first layer width (W₁). In embodiments, the second layer width (W₂) may be selected from the range of 0.1-5 mm, such as from the range of 0.5-3 mm.

As indicated above, the lens-like shape may in embodiments especially comprise 3D printed material comprising a light transparent material. In further embodiments, especially the lens-like shape may have the second layer height (H₂). In this way, the lens-like shape (and thus the stack modulation) may provide optical effects such as sparkling. Hence, in specific embodiments a part of the n^{th} layer in the stack section has a first layer height (H₁) and a part of the n^{th} layer in the modulation section has a second layer height (H₂), wherein especially 1.5*H₁≤H₂≤2.5*H₁. Further, the 3D printable material comprises a light transparent material; yet, the 3D printed material (of the lens-like shapes) may thus also be light transparent. Especially, the modulations may provide lens-like shapes; the lens-like shape may essentially be comprised by a substantially continuous layer, with modulations thereon which provide the lens-like shapes.

The term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point (Tₘ), and the printer head action may comprise heating the 3D printable material above the glass transition and in embodiments above the melting temperature (especially when the thermoplastic polymer is a semi-crystalline polymer). In yet another embodiment, the 3D printable material comprises a (thermoplastic) polymer having a melting point (Tₘ), and the 3D printing stage may comprise heating the 3D printable material to be deposited on the receiver item to a temperature of at least the melting point. The glass transition temperature is in general not the same thing as the melting temperature. Melting is a transition which may occur in crystalline polymers. Melting may happen when the polymer chains fall out of their crystal structures and become a disordered liquid. The glass transition may be a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former. The glass temperature may e.g. be determined with differential scanning calorimetry. The melting point or melting temperature can also be determined with differential scanning calorimetry.

As indicated above, the invention may thus provide a method comprising providing a filament of 3D printable material and printing during a printing stage said 3D printable material on a substrate, to provide said 3D item.

Materials that may especially qualify as 3D printable materials may be selected from the group consisting of metals, glasses, thermoplastic polymers, silicones, etc. Especially, the 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polycarbonate (PC), Polystyrene (PS), PE (such as expanded-high impact-Polythene (or polyethene), Low density (LDPE) High density (HDPE)), PVC (polyvinyl chloride) Polychloroethene, such as thermoplastic elastomer based on copolyester elastomers, polyurethane elastomers, polyamide elastomers polyolefine based elastomers, styrene based elastomers, etc .. Suitable thermoplastic materials, are also mentioned in WO2017/040893, which is herein incorporated by reference. In specific embodiments, the 3D printable material (and the 3D printed material) may comprise one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA). In embodiments, the 3D printable material (and the 3D printed material) may comprise one or more of PC, ABS, PC, and PMMA. In specific embodiments, the 3D printable material (and the 3D printed material) may comprise a combination of PC and ABS or may comprise a combination of PC and PMMA, though other combinations of materials may also be possible.

The term 3D printable material is further also elucidated below, but may especially refer to a thermoplastic material, optionally including additives, to a volume percentage of at maximum about 60%, especially at maximum about 30 vol. %, such as at maximum 20 vol. % (of the additives relative to the total volume of the thermoplastic material and additives).

The printable material may thus in embodiments comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The additive may have useful properties selected from optical properties, mechanical properties, electrical properties, thermal properties, and mechanical properties (see also above).

The printable material in embodiments may comprise particulate material, i.e. particles embedded in the printable polymeric material, which particles form a substantially discontinuous phase. The amount of particles in the total mixture may especially not be larger than 60 vol. %, relative to the total volume of the printable material. For optical and surface related effect number of particles in the total mixture is equal to or less than 20 vol. %, such as up to 10 vol. %, relative to the total volume of the printable material (including the particles). Hence, the 3D printable material may especially refer to a continuous phase of essentially thermoplastic material, wherein other materials, such as particles, may be embedded. Likewise, the 3D printed material especially refers to a continuous phase of essentially thermoplastic material, wherein other materials, such as particles, are embedded. The particles may comprise one or more additives as defined above. Hence, in embodiments the 3D printable materials may comprises particulate additives. Especially, however, the amount of light scattering particles in the total mixture may especially not be larger than 20 vol. %, such as not larger than 10 vol. %, more especially not larger than 5 vol. %, such as not larger than 1 vol. %. With the present invention, scattering particles may not be necessary to make the stack substantially opaque, as the stack modulations may prevent substantial opaqueness (even though the 3D printable material and the 3D printed material may be essentially light transparent).

The printable material may be printed on a receiver item. Especially, the receiver item can be the building platform or can be comprised by the building platform. The receiver item can also be heated during 3D printing. However, the receiver item may also be cooled during 3D printing. The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform, etc. Instead of the term “receiver item” also the term “substrate” may be used. The phrase “printing on a receiver item” and similar phrases include amongst others also printing on a separate substrate on or comprised by a printing platform, a print bed, a support, a build plate, or a building platform, etc. Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

Layer by layer printable material may be deposited, by which the 3D printed item may be generated (during the printing stage). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item.

Further, the invention relates to a software product that can be used to execute the method described herein. Therefore, in yet a further aspect the invention also provides a computer program product, when running on a computer which is functionally coupled to or comprised by a fused deposition modeling 3D printer, is capable of bringing about the method as described herein. Hence, in an aspect the invention (thus) provides a software product, which, when running on a computer is capable of bringing about (one or more embodiments of) the method (for producing a 3D item by means of fused deposition modelling) as described herein.

The herein described method provides 3D printed items. Hence, the invention also provides in a further aspect a 3D printed item obtainable with the herein described method. In a further aspect a 3D printed item obtainable with the herein described method is provided. Especially, the invention provides a 3D item comprising 3D printed material. In embodiments, the 3D item may comprise a stack comprising n layers of 3D printed material on top of each other. Especially, the stack may in embodiments comprise stack sections and stack modulations. For the stack sections may in embodiments apply: an n^{th} layer is (only) configured on an (n−1)^{th} layer and/or the (n−1)^{th} layer is (only) configured on an (n−2)^{th} layer. For (at least part of) the stack modulations may in embodiments apply: an n^{th} layer is partly configured on an (n−1)^{th} layer and partly on an (n−2)^{th} layer. In further embodiments, for (at least part of) the stack modulations may apply that the (n−1)^{th} layer is partly configured between the n^{th} layer and the (n−2)^{th} layer. In further embodiments, n>3. Especially, the 3D printed material may in embodiments comprise a light transmissive material. Hence, in a further aspect, the invention provides a 3D item comprising 3D printed material, wherein the 3D item comprises a stack comprising n layers of 3D printed material on top of each other, wherein the stack comprises stack sections and stack modulations, wherein: (a) for the stack sections applies: (i) an n^{th} layer is configured on an (n−1)^{th} layer and/or (ii) the (n−1)^{th} layer is configured on an (n−2)^{th} layer; (b) for (at least part of) the stack modulations applies: an n^{th} layer is partly configured on an (n−1)^{th} layer and partly on an (n−2)^{th} layer, and the (n−1)^{th} layer is partly configured between the n^{th} layer and the (n−2)^{th} layer; and (c) n>3, and the 3D printed material comprises a light transmissive material.

Especially, the 3D item comprises a plurality of layers of 3D printed material. The 3D item may comprise two or more, like at least 5, such as at least 10, like in embodiments at least 20 layers of 3D printed material. As indicated above, at least n layers of the 3D item may comprise the stack modulations. In embodiments, all layers (of the stack) of the 3D item may comprise the stack modulations. In alternative embodiments, some layers (of the stack) of the 3D item may comprise only the stack section.

The 3D printed item may comprise a plurality of layers on top of each other, i.e. stacked layers. The width (thickness) and height of (individually 3D printed) layers may e.g. in embodiments be selected from the range of 100-5000 μm, such as 200-2500 μm, with the height in general being smaller than the width. For instance, the ratio of height and width may be equal to or smaller than 0.8, such as equal to or smaller than 0.6.

Layers may be core-shell layers or may consist of a single material. Within a layer, there may also be a change in composition, for instance when a core-shell printing process was applied and during the printing process it was changed from printing a first material (and not printing a second material) to printing a second material (and not printing the first material).

At least part of the 3D printed item may include a coating.

Some specific embodiments in relation to the 3D printed item have already been elucidated above when discussing the method. As the 3D printed material may essentially be the (deposited) 3D printable material, embodiments described for the 3D printable material may also apply to the 3D printed material. Below, some specific embodiments in relation to the 3D printed item are discussed in more detail.

Hence, the 3D printed material may comprise a light transmissive material. The 3D printed material may in embodiments especially be transmissive for (one or more wavelengths of) visible light. Additionally or alternatively, the 3D printed material may in embodiments especially be transmissive for white light. In further embodiments, the 3D printed material may in embodiments comprise a light transparent material. The 3D printed material may in embodiments especially be transparent for visible light. In this way, the 3D item may be a diffuser for light having a high transmission. Such diffuser may especially be useful in lighting applications as it may provide relatively high yields due to its low absorption of light. Additionally or alternatively, the light transmissive (such as transparent) 3D printed material may provide a sparkling effect in the stack modulations. In embodiments, the stack modulation may comprise a (small) lens-like shape. Such lens-like shape may provide optical effects (such as sparkling) to the stack and/or 3D item.

As indicated in relation to the method of the invention, the stack modulations may in embodiments comprise a first part of the stack modulation. In the first part of the stack modulation, an n^{th} layer may in embodiments be partly configured on an (n−1)^{th} layer and partly on an (n−2)^{th} layer. Additionally or alternatively in the first part of the stack modulation the (n−1)^{th} layer may in embodiments be partly configured between the n^{th} layer and the (n−2)^{th} layer. In embodiments, the stack modulations may in embodiments further comprise a second part of the stack modulation.

In embodiments, the n layers (of the stack) may each comprise a layer shape (S). Especially, an (n−1)^{th} layer shape (Sₙ₋₁) may in embodiments differ from the n^{th} layer shape (Sn). Additionally or alternatively, the (n−1)^{th} layer shape (Sₙ₋₁) may in embodiments differ from the (n−2)^{th} layer shape (Sₙ₋₂). Additionally or alternatively, the n^{th} layer shape (Sₙ) may differ from the (n−2)^{th} layer shape (Sₙ₋₂). Herein, the n^{th} layer shape (Sₙ) may in embodiments refer to a central line through the n^{th} layer. Essentially, the n^{th} printing path (A_{Pn}) may become (after deposition of the 3D printable material) the n^{th} layer shape (Sₙ). Therefore, embodiments described above in relation to printing paths (A_{Pn}) may also apply to layer shapes (Sₙ).

Thus, the n layers (of the stack) may in embodiments each comprise a layer shape (S). Especially, (in the stack modulation) one or more of the (n−2)^{th} layer shape (Sₙ₋₂), the (n−1)^{th} layer shape (Sₙ₋₁), and the n^{th} layer shape (Sₙ) may in embodiments comprise an irregular shape. Additionally or alternatively, one or more of the (n−2)^{th} layer shape (Sₙ₋₂), the (n−1)^{th} layer shape (Sₙ₋₁), and the n^{th} layer shape (Sₙ) in the stack modulation may in embodiments have a wave-like shape. In embodiments, the wave-like shape may comprise any wave-like shape, such as based one or more of a block wave, a sine wave, a Fourier series, a composite wave, a sawtooth wave, and a peak period wave. Thus, one or more of the (n−2)^{th} layer shape (Sₙ₋₂), the (n−1)^{th} layer shape (Sₙ₋₁), and the n^{th} layer shape (Sₙ) in the stack modulation may in embodiments have a sine-like shape. The irregular sine has been described in detail above in relation to the method of the invention. In embodiments, the irregular sine may have a period selected from the range of 0.5*H₁−20*H₁, such as H₁−15*H₁, especially 4*H₁−10*H₁. As indicated above, H₁ is a layer height (H) of a part of a layer in a stack section. Hence, in specific embodiments, the n layers each comprise a layer shape (S), wherein one or more of the (n−2)^{th} layer shape (Sₙ₋₂), the (n−1)^{th} layer shape (Sₙ₋₁), and the n^{th} layer shape (Sₙ) comprise a shape of an irregular sine, wherein the irregular sine has a varying period selected from the range of H₁−15*H₁, wherein Hi is a layer height (H) of a part of a layer in a stack section.

Also similar to embodiments of the method of the invention, each of the (n−2)^{th} layer shape (Sₙ₋₂), the (n−1)^{th} layer shape (Sₙ₋₁), and the n^{th} layer shape (Sₙ) may in the stack modulation meander around a (respective) central path (A_{C}). A maximum deviation (d) of the n^{th} layer shape relative to the central path (A_{C}) may in embodiments be selected from the range of 0.05*W₁−1.5*W₁, such as from the range of 0.05*W₁−0.99*W₁, especially from the range of 0.1*W₁−0.9*W₁. As indicated above, W₁ is a layer width (W) of a part of a layer in a stack section. Especially, the central paths (A_{C}) may in embodiments define an overall shape of the stack (of the 3D item). Hence, in specific embodiments in the stack modulation each of the (n−2)^{th} layer shape (Sₙ₋₂), the (n−1)^{th} layer shape (Sₙ₋₁), and the n^{th} layer shape (Sₙ) meander around a central path (A_{C}), wherein a maximum deviation (d) of the n^{th} layer shape (Sₙ) relative to the central path (A_{C}) is selected from the range of 0.05*W₁−0.99*W₁, wherein W₁ is a layer width (W) of a part of a layer in a stack section.

As indicated above, for a predetermined layer of the n^{th} layer, the (n−1)^{th} layer, and the (n−2)^{th} layer, the stack sections may in embodiments have an accumulated first length LAI and the stack modulations have an accumulated second length L_{A2}. In embodiments, 0.01≤L_{A2}/L_{A1}≤10,000,000, such as 0.1≤L_{A2}/L_{A1}≤10,000, especially 0.5≤L_{A2}/L_{A1}≤1,000. Hence, in specific embodiments, for a predetermined layer of the n^{th} layer, the (n−1)^{th} layer, and the (n−2)^{th} layer, the stack sections have an accumulated first length L_{A1} and the stack modulations have an accumulated second length L_{A2}, wherein 0.1≤L_{A2}/L_{A1}≤10,000.

As also indicated above, a part of the n^{th} layer in the stack section has a first layer height (H₁) and a part of the n^{th} layer in the modulation section has a second layer height (H₂). In embodiments, 1.1*H₁≤H₂≤3*H₁, such as 1.5*H₁≤H₂≤2.5*H₁, such as 1.7*H₁≤H₂≤2.2*H₁. In further embodiments, the 3D printed material may comprise a light transparent material. Especially in such embodiments, the lens-like shapes may provide an optical effect (such as sparkling effect). Hence, in specific embodiments a part of the n^{th} layer in the stack section has a first layer height (H₁) and a part of the n^{th} layer in the modulation section has a second layer height (H₂), wherein 1.5*H₁≤H₂≤2.5*H₁; and wherein the 3D printed material comprises a light transparent material.

The (with the herein described method) obtained 3D printed item may be functional per se. For instance, the 3D printed item may be a lens, a collimator, a reflector, etc. The thus obtained 3D item may (alternatively) be used for decorative or artistic purposes. The 3D printed item may include or be provided with a functional component. The functional component may especially be selected from the group consisting of an optical component, an electrical component, and a magnetic component. The term “optical component” especially refers to a component having an optical functionality, such as a lens, a mirror, a light transmissive element, an optical filter, etc. The term optical component may also refer to a light source (like a LED). The term “electrical component” may e.g. refer to an integrated circuit, PCB, a battery, a driver, but also a light source (as a light source may be considered an optical component and an electrical component), etc. The term magnetic component may e.g. refer to a magnetic connector, a coil, etc. Alternatively, or additionally, the functional component may comprise a thermal component (e.g. configured to cool or to heat an electrical component). Hence, the functional component may be configured to generate heat or to scavenge heat, etc.

As indicated above, the 3D printed item may be used for different purposes. Amongst others, the 3D printed item may be used in lighting. Hence, in yet a further aspect the invention also provides a lighting device comprising the 3D item as defined herein. In a specific aspect the invention provides a lighting system comprising (a) a light source configured to provide (visible) light source light and (b) the 3D item as defined herein, wherein 3D item may be configured as one or more of (i) at least part of a housing, (ii) at least part of a wall of a lighting chamber, and (iii) a functional component, wherein the functional component may be selected from the group consisting of an optical component, a support, an electrically insulating component, an electrically conductive component, a thermally insulating component, and a thermally conductive component. Hence, in specific embodiments the 3D item may be configured as one or more of (i) at least part of a lighting device housing, (ii) at least part of a wall of a lighting chamber, and (iii) an optical element. As a relative smooth surface may be provided, the 3D printed item may be used as mirror or lens, etc. In embodiments, the 3D item may be configured as shade. A device or system may comprise a plurality of different 3D printed items, having different functionalities.

Returning to the 3D printing process, a specific 3D printer may be used to provide the 3D printed item described herein. Therefore, in yet a further aspect the invention also provides a fused deposition modeling 3D printer, comprising (a) a printer head comprising a printer nozzle, and (b) a 3D printable material providing device configured to provide 3D printable material to the printer head, wherein the fused deposition modeling 3D printer is configured to provide said 3D printable material onto a receiver item.

The printer nozzle may include a single opening. In other embodiments, the printer nozzle may be of the core-shell type, having two (or more) openings. The term “printer head” may also refer to a plurality of (different) printer heads; hence, the term “printer nozzle” may also refer to a plurality of (different) printer nozzles.

In embodiments, the 3D printer may be configured to print a plurality of 3D printable materials. In such embodiments, the 3D printer may comprise a plurality of 3D printable material providing devices and/or a plurality of printer nozzles. The 3D printable material may in embodiments be provided as a filament or as pellet. It will be clear to a person skilled in the art that many setups may be possible.

Especially, the 3D printer comprises a controller (or is functionally coupled to a controller) that is configured to execute in a controlling mode (or “operation mode”) the method as described herein. Instead of the term “controller” also the term “control system” (see e.g. above) may be applied. The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface. The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed. However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, which can only operate in a single operation mode (i.e. “on”, without further tunability). Hence, in embodiments, the control system may control in dependence of one or more of an input signal of a user interface, a sensor signal (of a sensor), and a timer. The term “timer” may refer to a clock and/or a predetermined time scheme.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of an embodiment of 3D printed material;

FIGS. 2a-2b schematically depict some embodiments of the invention;

FIGS. 3a-3c schematically depict some further embodiments of the method and 3D item;

FIG. 4 schematically depicts an application.

The schematic drawings are not necessarily to scale.

### DETAILED DESCRIPTION OF THE EMBODIMENTS

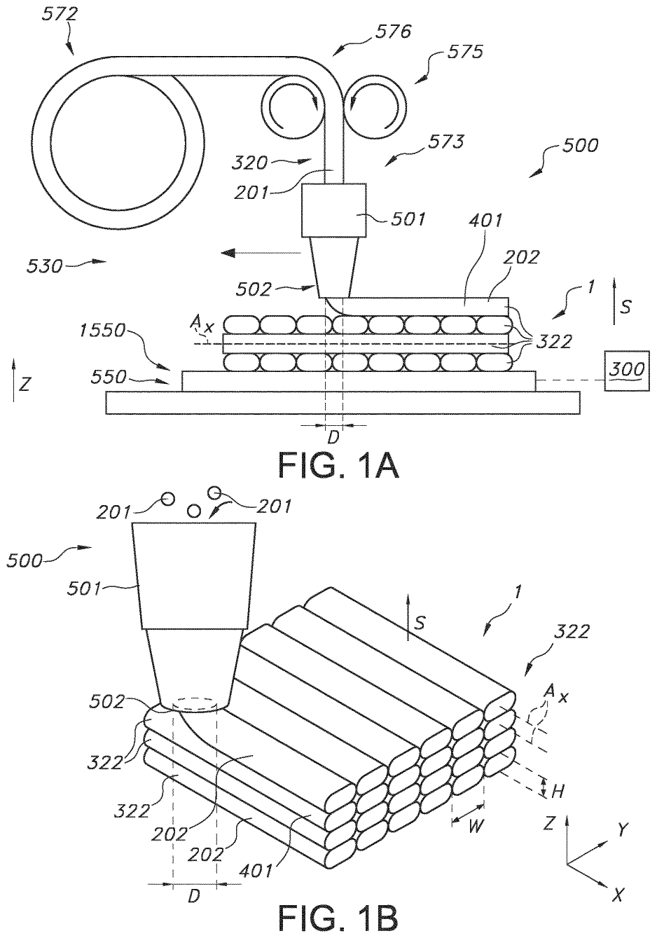

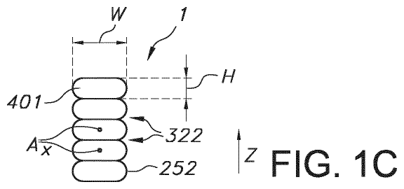

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. Here, only the printer head for providing 3D printed material, such as an FDM 3D printer head is schematically depicted. Reference 501 indicates the printer head. The 3D printer of the present invention may especially include a plurality of printer heads (see below). Reference 502 indicates a printer nozzle. The 3D printer of the present invention may especially include a plurality of printer nozzles, though other embodiments are also possible. Reference 320 indicates a filament of printable 3D printable material (such as indicated above). Instead of a filament also pellets may be used as 3D printable material. Both can be extruded via the printer nozzle. For the sake of clarity, not all features of the 3D printer have been depicted, only those that are of especial relevance for the present invention (see further also below). Reference 321 indicates extrudate (of 3D printable material 201).

The 3D printer 500 is configured to generate a 3D item 1 by layer-wise depositing on a receiver item 550 a plurality of layers 322 wherein each layer 322 comprises 3D printable material 201, such as having a melting point Tₘ. The 3D printable material 201 may be deposited on a substrate 1550 (during the printing stage). By deposition, the 3D printable material 201 has become 3D printed material 202. 3D printable material 201 escaping from the nozzle 502 is also indicated as extrudate 321. Reference 401 indicates thermoplastic material.

The 3D printer 500 may be configured to heat the filament 320 material upstream of the printer nozzle 502. This may e.g. be done with a device comprising one or more of an extrusion and/or heating function. Such device is indicated with reference 573 and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in an extrudate 321 downstream of the printer nozzle which becomes a layer 322 on the receiver item or on already deposited printed material. In general, the diameter of the extrudate 321 downstream of the nozzle 502 is reduced relative to the diameter of the filament 320 upstream of the printer head 501. Hence, the printer nozzle is sometimes (also) indicated as extruder nozzle. Arranging layer 322 by layer 322 on layer 322, a 3D item 1 may be formed. Reference 575 indicates the filament providing device, which here amongst others include the spool or roller and the driver wheels, indicated with reference 576.

Reference Ax indicates a longitudinal axis or filament axis.

Reference 300 schematically depicts a control system. The control system may be configured to control the 3D printer 500. The control system 300 may be comprised or functionally coupled to the 3D printer 500. The control system 300 may further comprise or be functionally coupled to a temperature control system configured to control the temperature of the receiver item 550 and/or of the printer head 501. Such temperature control system may include a heater which is able to heat the receiver item 550 to at least a temperature of 50° C., but especially up to a range of about 350° C., such as at least 200° C.

Alternatively or additionally, in embodiments the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction. Alternatively, the printer can have a head which can also rotate during printing. Such a printer has an advantage that the printed material cannot rotate during printing.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material. Hence, the nozzle 502 may effectively produce from particulate 3D printable material 201 a filament 320, which upon deposition is indicated as layer 322 (comprising 3D printed material 202). Note that during printing the shape of the extrudate may further be changes, e.g. due to the nozzle smearing out the 3D printable material 201/3D printed material 202. FIG. 1b schematically depicts that also particulate 3D printable material 201 may be used as feed to the printer nozzle 502.

Reference D indicates the diameter of the nozzle (through which the 3D printable material 201 is forced). However, the nozzle is not necessarily circular. FIG. 1b schematically depicts in 3D in more detail the printing of the 3D item 1 under construction. Here, in this schematic drawing the ends of the layers in a single plane are not interconnected, though in reality this may in embodiments be the case.

Reference H indicates the height of a layer. Layers are indicated with reference 322. Here, the layers have an essentially circular cross-section. Often, however, they may be flattened, such as having an outer shape resembling a flat oval tube or flat oval duct (i.e. a circular shaped bar having a diameter that is compressed to have a smaller height than width, wherein the sides (defining the width) are (still) rounded).

Hence, FIG. 1a schematically depict some aspects of a fused deposition modeling 3D printer 500, comprising (a) a first printer head 501 comprising a printer nozzle 502, (b) a filament providing device 575 configured to provide a filament 320 comprising 3D printable material 201 to the first printer head 501, and optionally (c) a receiver item 550, which can be used to provide a layer of 3D printed material 202.

FIG. 1b schematically depict some aspects of a fused deposition modeling 3D printer 500 (or part thereof), comprising a first printer head 501 comprising a printer nozzle 502, and optionally a receiver item (not depicted), which can be used to provide a layer of 3D printed material 202. Such fused deposition modeling 3D printer 500 may further comprise a 3D printable material providing device, configured to provide the 3D printable material 201 to the first printer head.

In FIGS. 1a-1b, the printable material or the printed material are indicated with the general indications printable material 201 and printed material 202, respectively. Downstream of the nozzle 502, the filament 320 with 3D printable material becomes, when deposited, layer 322 with 3D printed material 202. In FIG. 1b, by way of example the extrudate is essentially directly the layer 322 of 3D printed material 202, due to the short distance between the nozzle 502 and the 3D printed material (or receiver item (not depicted). FIG. 1c schematically depicts a stack of 3D printed layers 322, each having a layer height H and a layer width W. Note that in embodiments the layer width and/or layer height may differ for two or more layers 322. The layer width and/or layer height may also vary within a layer. Reference 252 in FIG. 1c indicates the item surface of the 3D item (schematically depicted in FIG. 1c).

Referring to FIGS. 1a-1c, the filament of 3D printable material that is deposited leads to a layer having a height H (and width W). Depositing layer 322 after layer 322, the 3D item 1 is generated. FIG. 1c very schematically depicts a single-walled 3D item 1.

Referring to FIGS. 1a-1c, for the stack sections may in embodiments apply that an n^{th} layer is (only) configured on an (n−1)^{th} layer. Additionally or alternatively, the (n−1)^{th} layer in the stack section may in embodiments (only) be configured on the (n−2)^{th} layer. This is as commonly used in FDM printing. Below, however, specific embodiments of the invention are described.

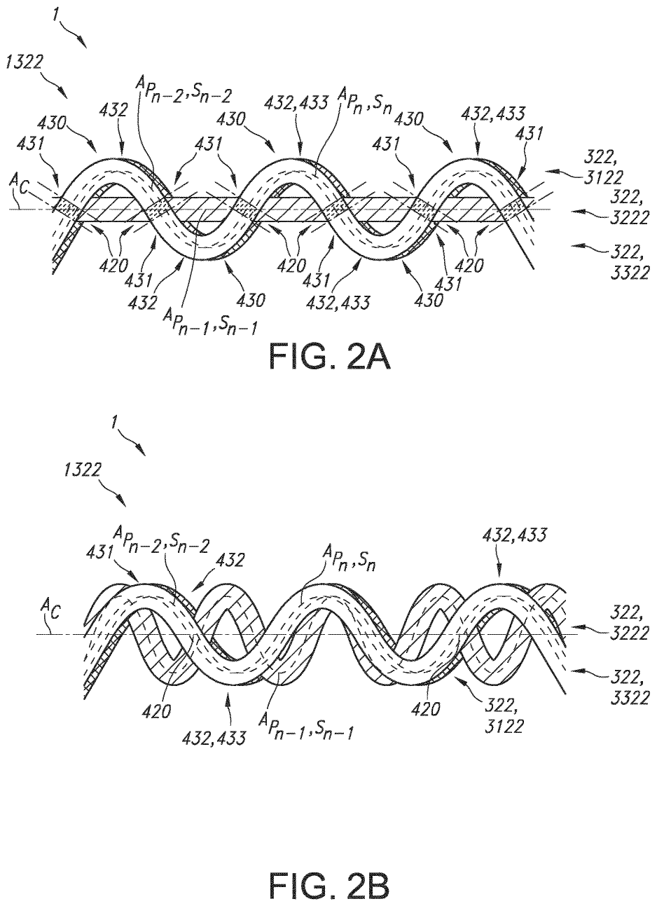

FIG. 2 a schematically depicts a 3D item 1 comprising a stack 1322 comprising n layers 322 of 3D printed material 202 on top of each other. In embodiments n≥3, here, n=3.

The 3D item 1 may especially comprise m layers 322 of 3D printed material 202. Hence, the method may comprise generating the 3D item 1, wherein the 3D item 1 comprises m layers 322. Especially, during generating the multiple layers 322, a stack 1322, as described herein, is generated. In embodiments, all layers 322 of the 3D item 1 may be part of the stack 1322, as described herein. In other embodiments, a subset of all layers 322 of the 3D item 1 may be part of the stack 1322, as described herein. Yet, in embodiments, at least parts of three or more layers of the 3D item 1 may be comprised by the stack 1322, as described herein, whereas other parts of three or more layers 322 may not be comprised by the stack 1322, as described herein.

In the most straightforward 3D printing known method, a stack 1322 of 3D printed layers 322 may be generated wherein the layers 322 are essentially on top of each other. There may be some offset, e.g. to make a curvature in the z-direction, but even then, the layers 322 may substantially be on top of each other and may follow substantially parallel printing paths (A_{P}). In the present invention, however, substantial deviations from substantially parallel printing paths (A_{P}) may be included, which may lead to stack sections 420 which may approximately or essentially be the same as obtained in the most straightforward 3D printing, and stack modulations 430.

In embodiments, the stack 1322 may comprise m layers 322. The number n may be a floating number within the m layers 322. By way of example, n can refer to the 7^{th} layer, and then n−1 refers to the 6^{th} layer, and n−2 refers to the 5^{th} layer. The method may comprise depositing 3D printable material 201 along n printing paths A_{Pn}. Especially, the method may comprise selecting the n printing paths A_{Pn} and printing conditions such that the stack 1322 comprises stack sections 420 and stack modulations 430. In the depicted embodiment, the (n−1)^{th} printing path A_{Pn-1} differs from an n^{th} printing path A_{Pn} and an (n−2)^{th} printing path A_{Pn-2}. In other embodiments, the (n−1)^{th} printing path A_{Pn-1} may differ from an n^{th} printing path A_{Pn} or an (n−2)^{th} printing path A_{Pn-2}. Especially, the method may provide a 3D item 1 comprising 3D printed material 202, wherein the 3D item 1 comprises the stack 1322 comprising n layers 322 of 3D printed material 202 on top of each other. Especially, the stack 1322 may comprise stack sections 420 and stack modulations 430.

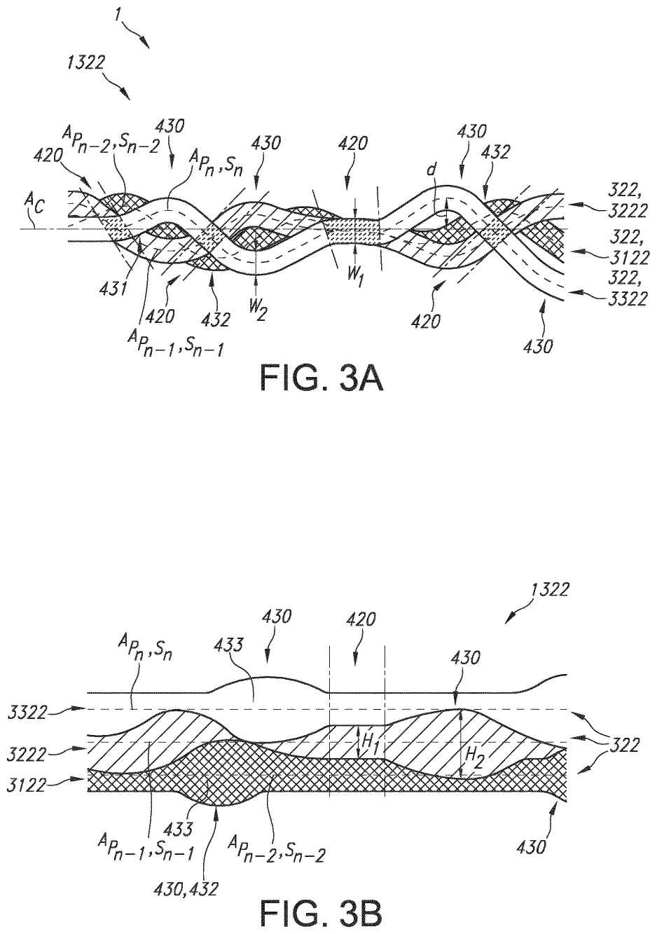

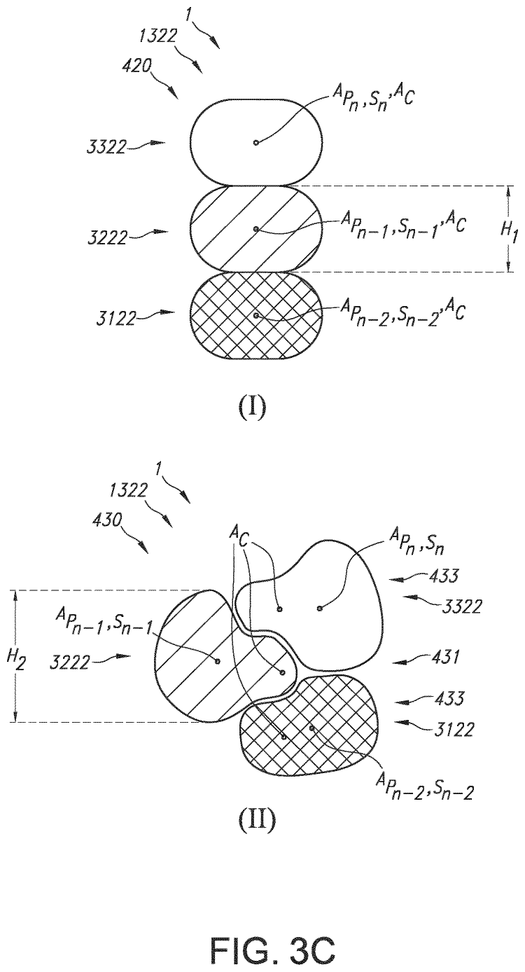

For the n^{th} layer 3322, the stack sections 420 and stack modulations 430 are indicated in FIG. 2a. In embodiments, the stack modulations 430 may especially comprise a first part 431 of the stack modulation 430. In embodiments, the stack modulations may further comprise a second part of the stack modulation. For a first part 431 of the stack modulation 430 may in embodiments apply: an n^{th} layer 3322 is partly configured on an (n−1)^{th} layer 3222 and partly on an (n−2)^{th} layer 3122, and the (n−1)^{th} layer 3222 is partly configured between the n^{th} layer 3322 and the (n−2)^{th} layer 3122. For the second part 432 of the stack modulation 430 may in embodiments apply: an n^{th} layer 3322 is configured on an (n−2)^{th} layer 3122. In embodiments, the first part 431 of the stack modulation 430 may especially be configured in the stack modulation 430 adjacent to a stack section 420. In embodiments, the second part 432 of the stack modulation 430 may especially be configured in the stack modulation 430 adjacent to the first part 431 of the stack modulation 430. The stack sections 420 and stack modulations 430 are depicted in more detail in FIG. 3c.

The n layers 322 (of the stack 1322) may each comprise a layer shape (S). Essentially, the layer shape (S) may correspond to the printing path (A_{P}) of that layer. Hence, in the depicted embodiment, the (n−1)^{th} layer shape Sn-1 differs from an n^{th} layer shape Sₙ and an (n−2)^{th} layer shape Sₙ₋₂. In other embodiments, the (n−1)^{th} layer shape Sₙ₋₁ differs from an n^{th} layer shape Sₙ or an (n−2)^{th} layer shape Sₙ₋₂.

In further embodiments, in the stack modulation 430 each of the (n−2)^{th} printing path A_{Pn-2}, the (n−1)^{th} printing path A_{Pn-1}, and the n^{th} printing path A_{Pn} meander around a (respective) central path A_{C}. In embodiments, a maximum deviation d of the n^{th} printing path relative to the central path A_{C}may be selected from the range of 0.05*W¹−0.99*W₁. Herein W₁ is a layer width W of a part of a layer 322 in a stack section 420. Hence, in such embodiments, in the stack modulation 430 each of the (n−2)^{th} layer shape Sₙ₋₂, the (n−1)^{th} layer shape Sₙ₋₁, and the n^{th} layer shape Sn meander around a (respective) central path A_{C}. In embodiments, a maximum deviation d of the n^{th} layer shape Sₙ relative to the central path A_{C} may be selected from the range of 0.05*W₁−0.99*W₁.

For a predetermined layer of the n^{th} layer 3322, the (n−1)^{th} layer 3222, and the (n−2)^{th} layer 3122, the stack sections 420 may have an accumulated first length L_{A1} and the stack modulations 430 may have an accumulated second length L_{A2}. The accumulated first length L_{A1} may especially be defined along the printing path (A_{P}) and/or layer shape (S) of the respective layer. The accumulated first length L_{A1} may especially be the sum of a length of each stack section 420 in the predetermined layer 322. Similarly, the accumulated second length L_{A2} may especially be defined along the printing path and/or layer shape of the respective layer. The accumulated second length L_{A2} may especially be the sum of a length of each stack modulation 430 in the predetermined layer 322. In embodiments 0.1≤L_{A2}/L_{A1}≤10,000.

FIG. 2b schematically depicts another embodiment of the invention. In the depicted embodiment, all three depicted layers 322 have a sine(-like) shape. FIGS. 2a and 2b both schematically depict embodiments wherein the (n−2)^{th} layer 3122 was deposited along the (n−2)^{th} printing path A_{Pn-2} and having an (n−2)^{th} layer shape Sₙ₋₂ which is identical to the n^{th} printing path A_{Pn} and n^{th} layer shape Sn of the n^{th} layer 3322. Only for visualization purposes, the n^{th} layer 3322 and the (n−2)^{th} layer 3122 are depicted slightly shifted from each other.

Returning to FIG. 2b, as part of the n^{th} layer 3322 is deposited on top of the (n−1)^{th} layer and part on top of the (n−2)^{th} layer, a height of the receiver item (previously deposited 3D printed material) may vary. Therefore, in embodiments, depositing the n^{th} layer 322 may further comprise displacing (part of) the (n−1)^{th} layer 3222 to create space for the nth layer 322 on one or more of the (n−1)^{th} layer 3222 and the (n−2)^{th} layer 3122.

In further embodiments, the method may comprise selecting one or more of (i) an extrusion rate v_{E}, (ii) a printing speed v_{P}, and (iii) a printing temperature T_{N} to provide the stack 1322. Especially, the extrusion rate v_{E}, the printing speed v_{P}, and the printing temperature T_{N} may in embodiments be constant during deposition of the layers 322 (of the stack 1322).

FIG. 3a schematically depicts an embodiment wherein an (n−1)^{th} printing path A_{Pn-1} differs from an n^{th} printing path A_{Pn} and an (n−2)^{th} printing path A_{Pn-2}, and wherein the n^{th} printing path A_{Pn} differs from the (n−2)^{th} printing path A_{Pn-2}. As the printing path may in embodiments define the layer shape, FIG. 3b also depicts an embodiment wherein an (n−1)^{th} layer shape Sₙ₋₁ differs from the n^{th} layer shape Sₙ and the (n−2)^{th} layer shape Sₙ₋₂, and wherein the n^{th} layer shape Sₙ differs from the (n−2)^{th} layer shape Sₙ₋₂. Especially, in the depicted embodiment in the stack modulation 430 one or more of the (n−2)^{th} printing path A_{Pn-2}, the (n−1)^{th} printing path A_{Pn-1}, and the n^{th} printing path A_{Pn} may comprise a shape of a (irregular) wave, such as a shape of an irregular sine. Hence, in such embodiments one or more of the (n−2)^{th} layer shape Sₙ₋₂, the (n−1)^{th} layer shape Sₙ₋₁, and the n^{th} layer shape Sₙ may comprise a shape of an irregular sine. In embodiments, the irregular sine may have a varying period selected from the range of H₁−15*H₁. H₁ may be a layer height H of a part of a layer 322 in a stack section 420. Additionally or alternatively, (parts of) the irregular sine may in embodiments be skewed. Additionally or alternatively, the irregular sine may have a varying amplitude. Amplitude may herein correspond to a (maximum) deviation d.

FIG. 3b schematically depicts a side view of the 3D item 1 comprising the stack 1322. Here, it may be observed that in stack modulations 430 of the n^{th} layer 3322, the (n−1)^{th} layer 3222 is partly hidden. In this way, the optical effects of the invention may be achieved.

Referring to FIGS. 3a-3b, the lens-like shapes may thus be on both sides of the stack. The lens-like shapes are indicated with references 433. As can be seen in FIG. 3b, the lens-like shapes 433 may especially be convex and may at least partly comprise curved edges.

FIG. 3c schematically depicts cross sections of (I) a stack section 420 and (II) a stack modulation 430. For the stack sections 420 may in embodiments especially apply: (i) an n^{th} layer 3322 is (only) configured on an (n−1)^{th} layer 3222 and/or (ii) the (n−1)^{th} layer 3222 is (only) configured on an (n−2)^{th} layer 3122. For the stack modulations 430 may in embodiments especially apply: an n^{th} layer 3322 is partly configured on an (n−1)^{th} layer 3222 and partly on an (n−2)^{th} layer 3122. For the stack modulations 430 may in embodiments further apply: and the (n−1)^{th} layer 3222 is partly configured between the n^{th} layer 3322 and the (n−2)^{th} layer 3122. Also here, it may be observed that in stack modulations 430 of the nth layer 3322, the (n−1)^{th} layer 3222 is partly hidden. In embodiments, the stack modulation may especially comprise a (small) lens-like shape. Especially, the 3D printable material 201 and hence the 3D printed material may in embodiments comprise a light transmissive material, especially a light transparent material. Such clear material may especially provide the sparkling effects. A part of the n^{th} layer 3322 in the stack section 420 may have a first layer height (H₁) and a part of the n^{th} layer 3322 in the modulation section 430 may have a second layer height (H₂). In embodiments 1.5*H₁≤H₂≤2.5*H₁. In this way, the (n−1)^{th} layer may be partially hidden. Further, it may be observed from FIG. 3c that the central paths Ac may in embodiments define an overall shape of the stack 1322 (of the 3D item 1).

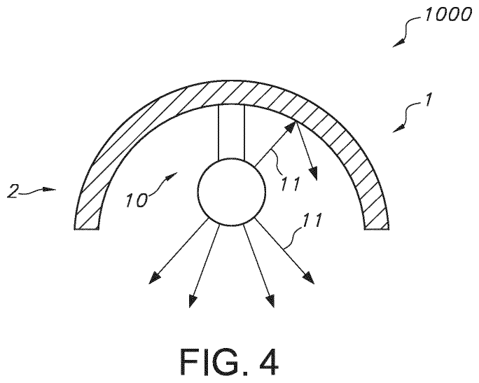

FIG. 4 schematically depicts an embodiment of a lamp or luminaire, indicated with reference 2, which comprises a light source 10 for generating light 11. The lamp may comprise a housing or shade or another element, which may comprise or be the 3D printed item 1. Here, the half sphere (in cross-sectional view) schematically indicates a housing or shade. The lamp or luminaire may be or may comprise a lighting device 1000 (which comprises the light source 10). Hence, in specific embodiments the lighting device 1000 comprises the 3D item 1. The 3D item 1 may be configured as one or more of (i) at least part of a lighting device housing, (ii) at least part of a wall of a lighting chamber, and (iii) an optical element. Hence, the 3D item may in embodiments be reflective for light source light 11 and/or transmissive for light source light 11. Here, the 3D item may e.g. be a housing or shade. The housing or shade comprises the item part 400. For possible embodiments of the item part 400, see also above.

The term “plurality” refers to two or more. The terms “substantially” or “essentially” herein, and similar terms, will be understood by the person skilled in the art.

The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”. Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. The article “a” or “an” preceding an element does not exclude the presence of a plurality of such elements.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In the claims, any reference signs placed between parentheses shall not be construed as limiting the claim.

The devices, apparatus, or systems may herein amongst others be described during operation. As will be clear to the person skilled in the art, the invention is not limited to methods of operation, or devices, apparatus, or systems in operation. It should be noted that the above-mentioned embodiments illustrate rather than limit the invention, and that those skilled in the art will be able to design many alternative embodiments without departing from the scope of the appended claims. The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

It goes without saying that one or more of the first (printable or printed) material and second (printable or printed) material may contain fillers such as glass and fibers which do not have (to have) influence on the on T_{g} or Tₘ of the material(s).

As 3D printing becomes more and more important for a standard production technology, there may be a drive for creating nice-looking sustainable 3D printed items, such as luminaires, more efficiently. Within lighting there may be a desire to have different colors, good color mixing, fault tolerance and good hiding of light source. In present methods, color mixing and hiding of the light source may be achieved by adding a diffuser. However, adding a diffuser may lower the efficiency of the total luminaire. Also, the very smooth 3D printed structures appear very sensitive for defects. Next to that sustainability becomes an important topic. Currently it is difficult to combine all these features into one product/surface.

Therefore, this invention describes a method on how to create an optimal hiding and sparkling structure. This is all done with clear material which enables good recycling and reuse of the materials.

This invention describes a 3D printed surface what creates very tiny, printed lenses and with that creates a special diffuse light sparkle. Used with a diffuse source, it may create a smooth sparkle surface. When used with direct white (phosphor based) LED, it may create an additional “blue” sparkle. This surface could be applied on many highly efficient products like in suspended luminaires or for home systems, office luminaires, shop luminaires etc. for an ultimate sparkling effect with 3D printing.

The method of the invention may comprise printing a layer comprising a “wobble”. Such wobbles may protrude from the item and form small lenses. The wobbles/lenses of a 3D printing layer may sometimes overlap at least half of the previous layer, sometimes almost the full previous layer. A small lens may be protruding from the surface where almost one layer in between is overlapped. This breaks the 3D printing structure. By the overlapping of such lenses approx. half of the previous layer may be “hidden”. When two of these lenses of different layers (by coincidence) meet each other than the layer in between may be “hidden”. The small 3D printed lenses may create the “extreme” sparkle. By playing with the parameters we could set the optimal lens overhang. With a microscope you can evaluate the surface. This method may be applied to build many different shapes.

To get this structure, we have tested: (a) macro vs micro textures, (b) smooth vs micro texture, (c) texture optimization comprising (i) layer height, (ii) “wobble” length, and (iii) “wobble” distance (left right). Using the method of the invention, 3D items were produced which may have one or more of (a) a fine texture what is nice to look at and may be sparkly (in on and off state), (b) 3D printing stripes may be gone and the items may look like a diffusor, (c) a clear (PC) material may be used, which may be easier to recycle as sustainable solution, (d) a smooth surface which could be combined with texture for multi-purpose, (e) a direct white LED may show nice extra color sparkle inside the structure visible with the blue sparkly points observed nearby, (f) a far field nice and homogenous light distribution, and (g) an increased or decreased whiteness of the surface and here with reflection, depending on the layer height.

This sustainable clear material used for this structure could be applied on many surfaces. Hiding, mixing, and sparkling may be very nice to see. By the use of clear material, we could recycle and re-use the material multiple times. There are no other additives or colors needed to set your luminaire color. A combination of an LED strip and spot could set the colors. In embodiments, a colored led strip may be twisted around a tube in the center of the item and may create the luminaire color, and a spot or bulb could be used for the white light downwards.

In embodiments, the 3D item may have a texture made with 3D printing, having a layer height selected from the range of 0.4 and 0.16 mm, especially a layer height of 0.24 mm. Smaller layer heights such as 0.08 mm may appear white and larger layer heights than 0.4 mm may show striping. Especially, the 3D printable material (and hence 3D printed material) may in embodiments be a clear material. In embodiments, the wobble may be created by repeatedly moving the printer head and/or printer nozzle from left to right of the designed surface. In embodiments, the wobble may in embodiments have a length selected from the range of 0.4-1.2 mm, such as 0.8 mm. Additionally or alternatively, the wobble distance (or maximum deviation (d)) may be at a golden ratio over a layer width. In embodiments, the wobble distance may be selected from the range of 0.8-1.4 mm. For example, an item having a layer width of 1.8 mm may have a wobble distance of 1.112 mm. As a result, the 3D item may have small overhang of clear material droplets to break the 3D printing lines.

1. A method for producing a 3D item by means of fused deposition modelling, the method comprising: a 3D printing stage comprising layer-wise depositing 3D printable material to provide the 3D item comprising 3D printed material, wherein the 3D item comprises a plurality of layers of 3D printed material; wherein the 3D printable material comprises a light transmissive material; wherein:
the method comprises generating a stack comprising n layers of 3D printed material on top of each other by depositing 3D printable material along n printing paths, wherein the n printing paths, and printing conditions are selected such that the stack comprises stack sections and stack modulations; wherein n≥3;
for the stack sections applies: (i) an n^{th} layer is configured on an (n−1)^{th} layer and/or (ii) the (n−1)^{th} layer is configured on an (n−2)^{th} layer;
for at least part of the stack modulations applies: an n^{th} layer is partly configured on an (n−1)^{th} layer and partly on an (n−2)^{th} layer, and the (n−1)^{th} layer is partly configured between the n^{th} layer and the (n−2)^{th} layer

2. The method according to claim 1, wherein an (n−1)^{th} printing path differs from an n^{th} printing path and/or an (n−2)^{th} printing path; and wherein the stack modulation comprises a lens-like shape.

3. The method according to claim 1, wherein the stack modulation comprises a first part of the stack modulation and a second part of the stack modulation wherein: (a) for the first part of the stack modulation applies: an n^{th} layer is partly configured on an (n−1)^{th} layer and partly on an (n−2)^{th} layer, and the (n−1)^{th} layer is partly configured between the n^{th} layer and the (n−2)^{th} layer; and (b) for the second part of the stack modulation applies: an n^{th} layer is configured on an (n−2)^{th} layer.

4. The method according to claim 1, wherein one or more of the (n−2)^{th} printing path, the (n−1)^{th} printing path, and the n^{th} printing path comprise a shape of an irregular sine, wherein the irregular sine has a varying period selected from the range of H₁−15*H₁, wherein H₁ is a layer height of a part of a layer in a stack section.

5. The method according to claim 1, wherein in the stack modulation each of the (n−2)^{th} printing path, the (n−1)^{th} printing path, and the n^{th} printing path meander around a central path, wherein a maximum deviation of the n^{th} printing path relative to the central path is selected from the range of 0.05*W₁−0.99*W₁, wherein W₁ is a layer width of a part of a layer in a stack section.

6. The method according to claim 1, wherein for a predetermined layer of the n^{th} layer the (n−1)^{th} layer and the (n−2)^{th} layer, the stack sections have an accumulated first length L_{A1} and the stack modulations have an accumulated second length L_{A2}, wherein 0.1<L_{A2}/L_{A1}<10,000.

7. The method according to claim 1, wherein depositing the n^{th} layer further comprises displacing the (n−1)^{th} layer to create space for the n^{th} layer on one or more of the (n−1)^{th} layer and the (n−2)^{th} layer.

8. The method according to claim 1, wherein the method comprises selecting (i) an extrusion rate v_{E}, (ii) a printing speed v_{P}, and (iii) a printing temperature T_{N} to provide the stack, wherein the extrusion rate v_{E}, the printing speed v_{P}, and the printing temperature T_{N} are constant during deposition of the layers.

9. The method according to claim 1, wherein a part of the n^{th} layer in the stack section has a first layer height and a part of the n^{th} layer in the modulation section has a second layer height, wherein 1.5*H₁≤H₂≤2.5*H₁; and wherein the 3D printable material comprises a light transparent material.

10. A 3D item comprising 3D printed material, wherein the 3D item comprises a stack comprising n layers of 3D printed material on top of each other, wherein the stack comprises stack sections and stack modulations wherein n≤3; wherein the 3D printed material comprises a light transmissive material; wherein: for the stack sections applies: (i) an n^{th} layer is configured on an (n−1)^{th} layer and/or (ii) the (n−1)^{th} layer is configured on an (n−2)^{th} layer and for at least part of the stack modulations applies: an n^{th} layer is partly configured on an (n−1)^{th} layer and partly on an (n−2)^{th} layer, and the (n−1)^{th} layer is partly configured between the n^{th} layer and the (n−2)^{th} layer.

11. The item according to claim 10, wherein the n layers each comprise a layer shape, wherein one or more of an (n−2)^{th} layer shape, an (n−1)^{th} layer shape, and an n^{th} layer shape comprise a shape of an irregular sine, wherein the irregular sine has a varying period selected from the range of H₁−15*H₁, wherein H₁ is a layer height of a part of a layer in a stack section

12. The item according to claim 11, wherein in the stack modulation each of the (n−2)^{th} layer shape, the (n−1)^{th} layer shape, and the n^{th} layer shape meander around a central path, wherein a maximum deviation of the n^{th} layer shape relative to the central path is selected from the range of 0.05*W₁−0.99*W₁, wherein W₁ is a layer width of a part of a layer in a stack section.

13. The item according to claim 10, wherein one or more of the following applies: (i) for a predetermined layer of the n^{th} layer, the (n−1)^{th} layer, and the (n−2)^{th} layer, the stack sections have an accumulated first length L_{A1} and the stack modulations have an accumulated second length L_{A2}, wherein 0.1≤L_{A2}/L_{A1}≤10,000; (ii) a part of the n^{th} layer in the stack section has a first layer height and a part of the n^{th} layer in the modulation section has a second layer height, wherein 1.5*H₁≤H₂≤2.5*H₁; and (iii) wherein the 3D printed material comprises a light transparent material.

14. A lighting device comprising the 3D item according to claim 9, wherein the 3D item is configured as one or more of (i) at least part of a lighting device housing, (ii) at least part of a wall of a lighting chamber, and (iii) an optical element.

15. (canceled)
